(19) United States
(12) Patent Application Publication
(10) Pub. No.: US 2008/0070149 A1
(43) Pub. Date: Mar. 20, 2008

(54) Pulverized toner, developing apparatus, process cartridge, image forming apparatus and image forming method

(76) Inventors: Hiroaki Kato, Nagaokakyo-shi (JP); Hideaki Yasunaga, Osaka (JP); Kazuoki Fuwa, Osaka (JP); Masayuki Hagi, Osaka (JP); Yoshihiro Mikuriya, Nishinomiya-shi (JP)

Correspondence Address: COOPER & DUNHAM, LLP, 1185 AVENUE OF THE AMERICAS, NEW YORK, NY, 10036, US

(21) Appl. No.: 11/900,292

(22) Filed: Sep. 10, 2007

(30) Foreign Application Priority Data
Sep. 14, 2006 (JP) 2006-248939

(51) Int. Cl. G03G 9/00; G03G 15/08

(52) U.S. Cl. 430/111.4; 399/252

(57) ABSTRACT

To provide a pulverized toner including: a wax-containing resin; a coloring material; and an external additive, wherein the pulverized toner has an average circularity of 0.890 to 0.930, a particle diameter of 6 μm to 10 μm, and a torque of 1.0 mNm to 2.5 mNm at a vacancy ratio 58% in the pulverized toner as measured by a torque measuring method using a conical rotor, and wherein the pulverized toner is a wax-containing pulverized toner for non-magnetic one component development.

### BACKGROUND OF THE INVENTION

1. Field of the Invention

The present invention relates to a pulverized toner for use in such image forming apparatus as copy machines, facsimiles and printers that use one component development with oilless fixing, and to a developing apparatus, process cartridge, image forming apparatus and image forming method that use the pulverized toner.

2. Description of the Related Art

In recent years, low-end LBPs have tended toward lower cost, greater compactness and higher speeds. In order to achieve lower cost and greater compactness, two-roller fixing that require no oil coating mechanism is indispensable. Furthermore, as a substitute for oil, it is necessary for toner to contain wax as a releasing agent. This, however, has encountered a problem of increased torque in the developing device because the adhesiveness and cohesiveness of toner increases.

In addition, a tandem system in which four photoconductors and four developing devices are lined up to accomplish development is effective for increasing printing speed. However, because the developing devices are arranged horizontally in order to lower the height of the printer body, it is necessary to adopt a configuration in which upright developing devices are provided. In this configuration the weight of toner particles in the device weighs on the developing roller, creating a problem that the torque further increases.

In order to avoid this problem, attempts have been made to lower toner adhesiveness by using a round polymerized toner and to lower toner cohesiveness by locking up a releasing agent inside the toner particle. This approach, however has met with difficulty in being used for the above-described low-end LBP due to the following causes: increased costs due to costs of secondary materials necessary for the reaction; safety problems associated with processing of volatile components and the like; problems associated with the fact that water-based equipment is used and thus the production site is limited because production is impossible except in an environment where large quantities of water can be used; and so forth.

In Japanese Patent Application Laid-Open No. 2003-330273, a developing apparatus is disclosed wherein a developer fills the developing chamber with a density larger than the looseness appearance density relative to the volume of the chamber and the fluidity of the developer is 89 or greater, and defines a fluidity which is calculated using a powder tester from the toner sieve residue. However, this method has a problem that there are large data variations and interoperator variations, so it is impossible to evaluate minute differences in fluidity among toners.

In Japanese Patent Application Laid-Open No. 2005-004192, an latent electrostatic image developing toner is disclosed that contains at least latent electrostatic image developing toner particles containing at least a binder resin, coloring agent and wax, and fine inorganic particles, wherein the torque value at a vacancy ratio of 0.54 as measured with a torque measuring method using a conical rotor is 2.4×10⁻³ N-m or less, and the bulk density of toner is 0.35 g/cm³ or higher. Through this, it became possible to prevent generation of abnormalities such as background smears, filming, image streakiness and to provide a developer and toner in which electrification capacity is sufficiently high and charge build up is also good, and high charge and fluidity can be maintained with small toner consumption to the carrier even after output of tens of thousands of images, and sufficient quality in image brightness can be obtained. However, the toner disclosed in Patent Literature 2 is directed to a toner for use with two-component developing systems, presenting a problem that this toner is not suitable as a wax-containing toner for non-magnetic one component development.

In consideration of the foregoing, it is an object of the present invention to provide an inexpensive, high-safety wax-containing pulverized toner for non-magnetic one component development, which pulverized toner prevents aggregation caused by its weight, a developing apparatus, process cartridge, image forming apparatus and image forming method that use the pulverized toner.

### BRIEF SUMMARY OF THE INVENTION

The features of the present invention, or means of solving the foregoing problems, are listed below.

The present invention is directed to a pulverized toner including: a wax-containing resin; a coloring material; and an external additive, wherein the pulverized toner has an average circularity of 0.890 to 0.930, a particle diameter of 6 μm to 10 μm, and a torque of 1.0 mNm to 2.5 mNm at a vacancy ratio of 58% in the pulverized toner as measured by a torque measuring method using a conical rotor, and wherein the pulverized toner is a wax-containing pulverized toner for non-magnetic one component development.

In the present invention, the external additive is a flow enhancer and is added in an amount of 2.5 parts by mass to 4.0 parts by mass per 100 parts by mass of the toner.

In the present invention the external additive has a primary particle diameter of 10 nm to 50 nm.

In the present invention, the external additive is silica and the adhesive strength of the external additive with respect to the pulverized toner is 30% to 80%.

In the present invention, the wax content of the pulverized toner is 3 parts by mass to 10 parts by mass per 100 parts by mass of the pulverized toner.

The present invention provides a upright developing apparatus that uses the above-described pulverized toner and wherein a developing roller is arranged vertically downward from the pulverized toner supply part and the pulverized toner is supplied vertically downward.

The present invention has a pulverized toner supply roller that contacts and faces the developing roller.

Furthermore, in the present invention, the supply of the pulverized toner to the developing roller is at least accomplished by gravity.

The present invention provides a process cartridge having the above-described upright developing apparatus.

The present invention provides an image forming apparatus having a fixing apparatus and the above-described upright developing apparatus, wherein the fixing apparatus employs a two-roll fixing system composed of a heating roller and a pressure roller.

In addition, the present invention has an fixing apparatus and the above-described upright developing apparatus, wherein the fixing apparatus employs oilless fixing that requires no oil coating on a fixing member.

The present invention is directed to an image forming method that involves the use the above-described pulverized toner.

With the foregoing means, the present invention can provide an inexpensive, high-safety wax-containing pulverized toner for non-magnetic one component development that prevents aggregation caused by its weight, a developing apparatus, process cartridge, image forming apparatus and image forming method that use the pulverized toner.

### BRIEF DESCRIPTION OF THE SEVERAL VIEWS OF THE DRAWINGS

FIG. 1 is a drawing showing a torque meter using a conical rotor of the present invention.

FIG. 2A is a drawing showing a conical rotor.

FIG. 2B is a drawing showing another conical rotor.

FIG. 3 is a drawing showing the attachment of a conical rotor to a torque meter.

FIG. 4 shows a cross-sectional view of a principle portion of an image forming apparatus equipped with the developing apparatus and process cartridge according to an embodiment of the present invention.

FIG. 5 shows a cross-sectional view of the developing apparatus and process cartridge of an embodiment of the present invention.

FIG. 6 is a drawing showing a fixing apparatus.

### DETAILED DESCRIPTION OF THE INVENTION

The preferred embodiments of the present invention will be described below with reference to the drawings. It will be apparent for those skilled in the art that these embodiments are susceptible to alterations and modifications within the scope of the attached claims, and that such alterations and modifications are within the scope of the claims. The following explanation provides examples of the preferred embodiments of the present invention for illustration purpose only, and shall not be construed as limiting the scope of the present invention.

The pulverized toner of the present invention has an average circularity of 0.890 to 0.930. When the average circularity of the pulverized toner is smaller than 0.890, the transfer efficiency drops, granularity worsens and image quality reduces. In addition, when the average circularity is greater than 0.930, it results in poor toner cleaning and reduces image quality.

In addition, the pulverized toner of the present invention has a particle diameter of 6 μm to 10 μm. When the pulverized toner particle diameter is smaller than 6 μm, the adhesiveness between toner particles increases, and thus torque increases. In addition, when the particle diameter is larger than 10 μm, granularity decreases, causing problems with respected to image quality. Furthermore, it is preferable for the particle diameter to be in a range of 7 μm to 9 μm.

Furthermore, the pulverized toner of the present invention has a torque in the range of 1.0 mNm to 2.5 mNm at a vacancy ratio of 58% for the pulverized toner as measured by a torque measuring method using a conical rotor. When the torque (measured using a conical rotor) at a vacancy ratio of 58% is smaller than 1.0 mNm, suitable torque/fluidity cannot be obtained, uncontrolled transport volume occurs on the developing roller and unevenness occurs on images. In addition, when this is greater than 2.5 mNm, torque increases, clogging occurs within the developing device, leading to image quality problems. Furthermore, the torque is preferably 1.2 mNm to 2.2 mNm.

The external additive for the pulverized toner of the present invention is a fluidity enhancer and the toner contains 2.5 parts by mass to 4.0 parts by mass of external additive per 100 parts by mass of pulverized toner. When the external additive content in the pulverized toner is less than 2.5%, the external additive coverage is insufficient, toner adhesiveness increases, torque increases and transfer skips occur. In addition, when the external additive is greater than 4.0%, the external additive separates from toner particles and adheres to the photoconductor, causing blank spots to appear in the image. Furthermore, the external additive is preferably added in an amount of 3 parts by mass to 3.8 parts by mass.

In addition, the pulverized toner of the present invention has a wax content of 3 parts by mass to 10 parts by mass per 100 parts by mass of pulverized toner. When the wax content of the toner is less than 3 parts by mass, no separation effect is obtained and the toner sticks to the roller during a fixing operation. In addition, when this is greater than 10 parts by mass, seepage of the wax occurs readily in the developing device, fixing occurs on the regulation blade and the like and streaks occur in the image.

The method for measuring torque using a conical rotor of the present invention will now be explained.

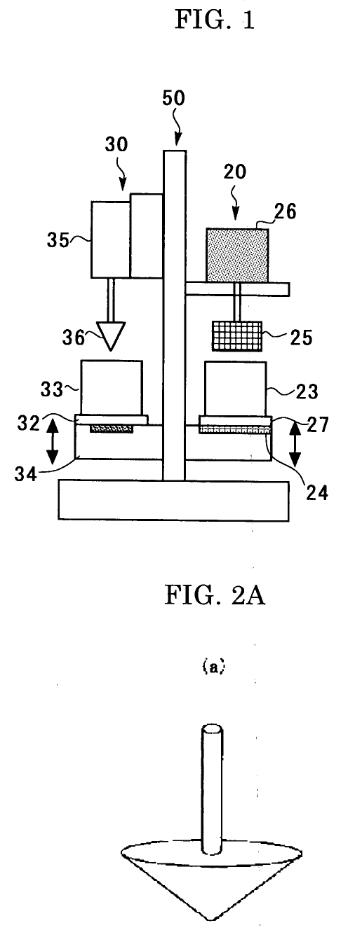

FIG. 1 shows a torque meter using the conical rotor of the present invention. The torque meter 50 is composed of a compression zone 20 and a measurement zone 30. The compression zone 20 is made up of a sample container into which powder is poured, an elevator stage 24 that raises and lowers this container, a piston 25 that causes compression and a weight 26 that adds weight to the piston 25. This composition is but one example and is intended to be illustrative of the present invention and not limiting. With this configuration the sample container 23 into which a powder has been poured is raised, is caused to make contact with the compression piston 25, is raised further so that the weight of the piston 25 and weight 26 are fully applied and so that the weight 26 is lifted up from the support plate, and is maintained there for a set time. Following this, the elevator stage 24 on which the sample container 23 storing powder is lowered and the piston 25 separates from the powder surface. The piston 25 may be any material, but the surface that presses on the powder needs to be smooth. For this reason, it is preferable to employ materials that are easy to work with, have a solid surface and do not undergo quality change. In addition, it is necessary that there occurs no powder adhesion due to electrification, so conductive materials are suitable. Examples of such materials include SUS, Al, Cu, Au, Ag and brass. Furthermore, this material is preferably brass. In the following Examples, brass was used.

The measurement zone 30 is composed of a container 33 into which powder is poured, an elevator stage 34 for raising and lowering that container, a load cell 32 for measuring the weight and a torque meter 35 for measuring the torque of the powder. Note that this configuration is only a non-exclusive example. A conical rotor 36 is attached to the tip of the shaft, and anchors the shaft itself in relation to movement in the vertical direction. The elevator stage 34, in the center of which is the sample container 33 in which powder has been poured, is enabled to move up and down, and by raising the container 33, the conical rotor 36 penetrates into the center of the container 33 while rotating. The torque applied to the conical rotator 36 is detected by the torque meter 35 above and the load applied to the container 33 holding the powder is detected by the load cell 32 below the container 33. The amount of movement of the conical rotor 36 is measured by an unrepresented position detector. This configuration is one example, and other configurations are possible, such as the shaft itself rising and falling.

In addition, the mass of the powder is measured using the load cell 32 below the container 33, and from height information and weight information regarding the powder phase, the compression status of the powder phase may be evaluated. Computation of this information is accomplished using an unrepresented electronic calculator.

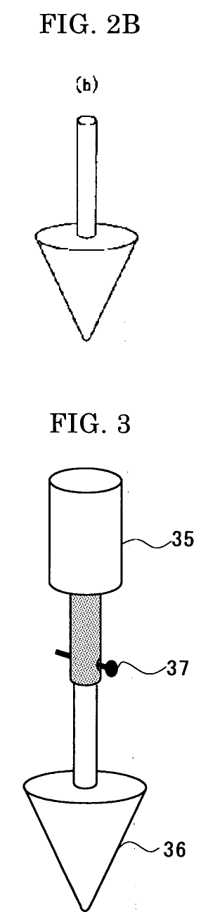

FIG. 2 shows the conical rotor. The shape of the conical rotor 36 may have a vertical angle of 20° (see FIG. 2B) to 150° (see FIG. 2A), as discussed above. The length of the conical rotor 36 needs to be increased so that the conical-shaped rotor portion is inserted sufficiently into the powder phase.

There are no conditions on the material of the sample container 33, but an electrically conductive material is suitable so that no effects from electrification on the powder occur. In addition, it is best if the surface is close to a mirror surface so as to minimize soiling and enable measuring while changing powder. The size of the container 33 is important, and it is necessary to select a diameter size that is larger than the diameter of the conical rotor 36 so that when the conical rotor 36 is inserted while rotating, no effects on the walls of the container occur.

FIG. 3 shows attachment of the conical rotor to the torque meter. Attachment of the conical rotor 36 to the torque meter 35 is accomplished by an attachment screw 37, as shown in FIG. 3, so that conical rotors 36 of various different materials can be easily attached and detached. Because attaching and detaching are accomplished with one screw, conical rotors 36 made of various materials can be easily exchanged, so that the fluidity between various materials and the powder can be evaluated.

The torque meter 35 is preferably a highly sensitive type and a non-contact format is suitable. For the load cell 32, one with a wide load range and high resolution is suitable. For the position detector, there are displacement sensors or the like using linear scales and light, but in terms of precision, specifications of 0.1 mm or less are suitable. For the elevator, one that can be precisely driven using a servo motor or stepping motor is preferred.

For measurements, a predetermined amount of powder is placed in the container 23, and the container 23 is mounted on the apparatus. Thereafter, the elevator stage 24 is raised to the compression zone, the powder surface is pressed by the piston, which applies a fixed load, and a compressed powder phase status is created. After compressing for a fixed time, the container 23 is lowered and returned to the original position.

Following this, the container 23 containing the powder whose compression status has been measured is placed on the elevator stage 34 of the measurement zone 30 as a container 33. This action may be accomplished by moving from the compression zone 20 to the measurement zone 30 by causing the elevator stage 34 to rotate.

Furthermore, the conical rotor 36 penetrates into the powder phase in the container 33 while rotating. When conducting torque and load measurement, this is accomplished at a determined rotational frequency and insertion speed. The rotational direction of the conical rotor is arbitrary determined. If the insertion distance of the conical rotor 36 is shallow, the value of the torque and load is small and problems occur with respected to data reproducibility and the like, so it is best to insert the rotor deeply to a region where reproducibility of the data is possible. In field tests conducted by the inventor, virtually stable measurements were possible if the rotor was inserted 5 mm or more.

Measurement mode is as follows:

(1) The container 23 is filled with powder.

(2) The powder phase is compressed by the piston and a compressed state is created.

(3) The conical rotor 36 is inserted while rotating and the torque and load at that time are measured.

(4) The insertion action is stopped when the conical rotor 36 has penetrated to a predetermined depth from the toner surface layer.

(5) The action of extracting the conical rotor 36 is begun.

(6) The tip of the conical rotor 36 is removed from the powder phase surface and the action of extracting the conical rotor 36 is halted when it has become completely free (initial home position), and rotation is also halted.

Measurements are accomplished by repeating the steps (1) through (6) above. These steps may also be conducted continuously.

As an evaluation method for the compressed state, there is a method that calculates the vacancy ratio. In this measurement method, the vacancy ratio of the powder phase is important and stable measurement can be accomplished when the vacancy ratio is 0.4 or higher. When the vacancy ratio is less than 0.4, minute differences in conditions in the compressed state affects the torque and load, making stable measurement difficult. The range of vacancy ratio for the powder phase is 0.4 to 0.7, including values as measured with various kinds of measurement methods, and when this is greater than 0.7, powder scattering occurs, making this unsuitable for measurement.

In the present invention, measurements are made for various weights of the weight 26, plotting a linear regression line for the vacancy ratio and torque values, and calculating the torque at a vacancy ratio of 58%.

The measurement method for the particle size distribution of the toner particles will now be explained.

Measurement instruments for the particle size distribution of the toner particles using the Coulter Counter method include Coulter Counter TA-II and Coulter Multisizer II (both made by Beckman Coulter Inc.). The measurement method is described below. First, 0.1 mL to 5 mL of a surfactant (preferably, alkyl benzene sulfonate) is added as a dispersing agent to 100 mL to 150 mL of electrolyte solution. As an electrolyte, 1% NaCl solution is prepared using grade-A sodium chloride, and for example ISOTON-II (made by Beckman Coulter) can be used herein. The analyte is added in an amount of 2 mg to 20 mg in terms of solid content. The electrolyte in which the sample is suspended undergoes around 1-3-minute dispersion treatment in an ultrasonic disperser, and the volume and number of toner particles or toner are measured by the aforementioned measurement apparatus using an aperture of 100 μm, and the volume distribution and particle size distribution are calculated. From the distributions obtained, the weight-average particle diameter (Dv) and the number-average particle diameter of particles (Dp) of the toner can be found. Thirteen channels are used: 2.00 μm to less than 2.52 μm; 2.52 μm to less than 3.17 μm; 3.17 μm to less than 4.00 μm; 4.00 μm to less than 5.04 μm; 5.04 μm to less than 6.35 μm; 6.35 μm to less than 8.00 μm; 8.00 μm to less than 10.08 μm; 10.08 μm to less than 12.70 μm; 12.70 μm to less than 16.00 μm; 16.00 μm to less than 20.20 μm; 20.20 μm to less than 25.40 μm; 25.40 μm to less than 32.00 μm; 32.00 μm to less than 40.30 μm. Particles with a diameter of 2.00 μm or greater and less than 40.30 μm are targeted.

The average circularity of the present invention will now be explained.

A suitable method for shape measurement is an optical detection band method that comprises the step of passing a particle-containing suspension through an imaging part on a flat plate, so that particle images are optically detected by a CCD camera for analysis. It was discovered that toner with an average circularity, which is the circumference of an equivalent circle with the same area as the projection area obtained by this method divided by the circumference of the actual particle, of 0.890 or greater is effective in creating a high-precision image that is reproducible with suitable concentration. More preferably, the average circularity is 0.890 to 0.930. This value is a value measured as the average circularity by the FPIA-2000 flow particle image analysis system.

As a specific measurement method, 100 mL to 150 mL water from which solid impurities have been removed is placed in advance in a container and 0.1 mL to 0.5 mL of a surfactant, preferably alkyl benzene sulfonate, is added as a dispersing agent, and then 0.1 g to 0.5 g of the measurement sample is added. The suspension in which the sample is dispersed undergoes around 1-3 minutes of dispersion processing by an ultrasonic disperser, and the dispersion liquid concentration of 3000 to 10,000 units/mL can be obtained by measuring the toner is shape and distribution with the aforementioned apparatus.

The adhesion strength of the external additive of the present invention will now be explained.

Two grams of toner is added to 30 cc of a surfactant solution diluted ten-fold, and after this has been sufficiently mixed, energy is applied for one minute at 40 W using an ultrasonic homogenizer, the toner is separated, cleaned and dried and the ratio of the amount of inorganic particles adhering before and after the treatment is calculated using a fluorescent x-ray analysis apparatus. Fluorescent x-ray analysis was accomplished using the XRF1700 wavelength dispersion fluorescent X-ray analysis device made by Shimadzu Corp. by creating toner pellets by applying 1 N/cm² of force to 2 g each of dried toner obtained through the above-described treatment and pre-treatment toner for 60 seconds and measuring the elements characteristic of the inorganic fine particles (such as silicon in the case of silica) using the calibration curve method.

As a result, it was determined that the preferred adhesion strength of the fluidity enhancer with respect to the toner core is 30% to 80%. When the adhesion strength of the external additive with respect to the toner is less than 30%, the external additive fixed on the toner core is sparse, a free external additive effects on images. In addition, when this is greater than 80%, its embedding in the toner core proceeds too far and its effect as a spacer reduces. Furthermore, the strength is preferably 40% to 65%.

With the present invention, by having wax mixed with the resin, bleeding of the wax is prevented and it is possible to suppress increases in the toner adhesion through free wax, and it is possible to achieve the developing apparatus configuration of the present invention.

The toner will be described below.

In consideration of the effect on image quality, the toner has a volume-average particle diameter of 5 μm to 12 μm (as measured by a Coulter Multisizer III), and more preferably 6 μm to 10 μm.

In addition, a releasing ingredient is included in the toner nucleus so that the separation performance between the paper and fixing apparatus is maintained and improved when the toner image formed on the transfer paper is fixed.

The toner particles that constitute the toner of the present invention used in forming full-color images contain therein the later-described first binder resin containing a hydrocarbon wax internally added, a second binder resin, a colorant, an electric charge control agent and an external additive.

The binder resins will now be described.

The types of first and second binder resins are not particularly limited, and may be binder resins commonly known in the field of full-color toners, for example polyester resins, (meth)acrylic resins, styrene-(meth)acrylic copolymer resins, epoxy resins COC (cyclic olefin resin (for example TOPAS-COC (made by Ticona))), but from the perspective of oilless fixing, it is preferable to use polyester resins for both the first binder resin and the second binder resin.

As the polyester resins preferably used in the present invention, it is possible to use polyester resins obtained by polycondensation of a polyvalent alcohol component and a polyvalent carboxylic acid component. Of the polyvalent alcohol component, examples of divalent alcohol components that can be cited include: bisphenol A alkylene oxide additives such as polyoxy propylene (2,2)-2,2-bis(4-hydroxy phenyl)propane, polyoxy propylene (3,3)-2,2-bis(4-hydroxy phenyl)propane, polyoxy propylene (6)-2,2-bis(4-hydroxy phenyl)propane and polyoxy ethylene (2,0)-2,2-bis(4-hydroxy phenyl)propane; ethylene glycol, diethylene glycol, triethylene glycol, 1,2-propylene glycol, 1,3-propylene glycol, 1,4-butane diol, neopentyl glycol, 1,4-butene diol, 1,5-petane diol, 1,6-hexane diol, 1,4-cyclohexanedimethanol, dipropylene glycol, polyethylene glycol, polytetramethylene glycol, bisphenol A, hydrogenated bisphenol A and the like. As alcohol components that are trivalent or higher, examples that can be cited include: sorbitol, 1,2,3,6-hexane tetrol, 1,4-sorbitan, pentaerythritol, dipentaerythritol, tripentaerythritol, 1,2,4-butane triol, 1,2,5-pentane triol, glycerol, 2-methyl propane triol, 2-methyl-1,2,4-butane triol, trimethylol ethane, trimethylol propane, 1,3,5-trihydroxymethyl benzene and the like.

In addition, among polyvalent carboxylic acid components, as divalent carboxylic acid components, examples that can be cited include: maleic acid, fumaric acid, citraconic acid, itaconic acid, glutaconic acid, phthalic acid, isophthalic acid, terephthalic acid, cyclohexane carboxylic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, isooctenyl succinic acid, n-octyl succinic acid or isooctyl succinic acid, or anhydrides or lower alkyl esters of these acids.

As trivalent or higher carboxylic acid, examples that can be cited include: 1,2,4-benzene tricarboxylic acid (trimellitic acid), 1,2,5-benzen tricarboxylic acid, 2,5,7-naphthylene tricarboxylic acid, 1,2,5-hexane tricarboxylic acid, 1,3-dicarboxyl-2-methyl-2-methylene carboxy propane, 1,2,4-cyclohexan tricarboxylic acid, tetra(methylene carboxyl)methane, 1,2,7,8-octane tetracarboxylic acid, pyromellitic acid or empole trimer acid or anhydrides or lower alkyl esters of these acids.

In addition, as polyester resin in the present invention it is possible to ideally use resins (hereafter simply referred to as “vinyl polyester resins”) obtained by accomplishing concurrently in the same container a polycondensation reaction that yields polyester resin and a radical polymerization reaction that yields vinyl resin using a raw monomer of polyester resin, a raw monomer of vinyl resin and a compound of a monomer reacted with raw monomers of both resin. The monomer that reacts with the raw monomers of both resins is, in other words, a monomer used in obtaining both the polycondensation reaction and the radical polymerization reaction. That is to say, this is a monomer having a carboxyl radical for obtaining a polycondensation reaction and a vinyl radical for obtaining a radical polymerization reaction, and for example may be fumaric acid, maleic acid, acrylic acid, methacrylic acid or the like.

As raw monomers of polyester resin, the above-described polyvalent alcohol components and polyvalent carboxylic acid component may be cited. In addition, as the raw monomer of vinyl resin, examples that can be cited include: styrene or styrene derivatives such as styrene, o-methyl styrene, m-methyl styrene, p-methyl styrene, α-methyl styrene, p-ethyl styrene, 2,4-dimethyl styrene, p-tert-butyl styrene or p-chlorostyrene; ethylene unsaturated monoolefins such as ethylene, propylene, butylenes or isobutylene; alkyl esters of methacrylic acid such as methyl methacrylate, n-propyl methacrylate, isopropyl methacrylate, n-butyl methacrylate, isobutyl methacrylate, t-butyl methacrylate, n-pentyl methacrylate, isopentyl methacrylate, neopentyl methacrylate, 3-(methyl) butyl methacrylate, hexyl methacrylate, octyl methacrylate, nonyl methacrylate, decyl methacrylate, undecyl methacrylate or dodecyl methacrylate; alkyl esters of acrylic acid such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate or dodecyl acrylate; unsaturated carboxylic acids such as acrylic acid, methacrylic acid, itaconic acid or maleic acid or acrylonitrile, maleic acid esters, itaconic acid esters, vinyl chloride, vinyl acetate, vinyl benzoate, vinyl methyl ethyl ketone, vinyl hexyl ketone, vinyl methyl ether, vinyl ethyl ether or vinyl isobutyl ether. As polymerization initiation agents when polymerizing the raw monomers of vinyl resin, examples that can be cited include: azo or diazo polymerization initiation agents such as 2,2′-azobis(2,4-dimethyl valeronitrile), 2,2′-azobisisobutylonitrile, 1,1′-azobis(cyclohexane-1-carbonitrile) or 2,2′-azobis-4-methoxy-2,4-dimethyl valeronitrile; or peroxide polymerization initiation agents such as benzoyl peroxide, dicumyl peroxide, methyl ethyl ketone peroxide, isopropyl peroxycarbonate or lauroyl peroxide.

The above-described various polyester resins may be preferably used as the first binder resin and the second binder resin, but among them, it is more preferable to use the first binder resin and second binder resin indicated below from the viewpoint of further improving the separation and anti-offset properties as a toner for oilless fixing.

A more preferable first binder resin is a polyester resin obtained through polycondensation of the above-described polyvalent alcohol component and polyvalent carboxylic acid component, and more particularly, is a polyester resin obtained by using a bisphenol-A alkylene oxide additive as the polyvalent alcohol component and terephthahc acid or fumaric acid as the polyvalent carboxylic acid component.

A more preferable second binder resin is a vinyl polyester resin, and more particularly a vinyl polyester resin obtained using bisphenol-A alkylene oxide additive, terephthalic acid, trimellitic acid and succinic acid as raw monomers for polyester resin, styrene and butyl acrylate as the raw monomers for vinyl resin and fumaric acid as the reactive monomer for both.

In the present invention, a hydrocarbon wax is added when synthesizing the first binder resin, as described above. In adding the hydrocarbon wax to the first binder resin in advance, when the first binder resin is synthesized it is sufficient to synthesize the first binder resin in a state with the hydrocarbon wax added to the monomer for synthesizing the first binder resin. For example, it is sufficient to accomplish the polycondensation reaction with the hydrocarbon wax added to the acid monomer and alcohol monomer that make up the polyester resin as the first binder resin. When the first binder resin is a vinyl polyester resin, it is sufficient to accomplish the polycondensation reaction and radical polymerization reaction in a state with the hydrocarbon wax added to the raw monomer of the polyester resin, with the monomer stirred and heated while dripping into this the raw monomer of the vinyl resin.

The wax will now be explained.

In general, waxes with low polarity are preferred for the releasing property from the fixing member roller. The wax used in the present invention is a hydrocarbon wax with low polarity.

The hydrocarbon wax is a wax made of only hydrogen atoms and carbon atoms, and does not contain ester groups, alcohol groups, amide groups or the like. Among the specific hydrocarbon waxes that can be cited are: polyolefin waxes such as copolymers of polyolefin, polypropylene, ethylene and propylene; petroleum waxes such as paraffin waxes or microcrystalline waxes; or synthetic wax such as FischerTropsch wax. Of these, polyethylene wax, paraffin wax and Fischer Tropsch wax are preferable in the present invention, and more preferably polyethylene waxes or paraffin waxes.

The wax dispersion agent will now be explained.

The toner of the present invention may contain a wax dispersion agent to aid dispersion of wax. There are no particular limitations on the wax dispersion agent and those that are commonly known can be used. Among those that can be cited are polymers or oligomers in which units with high solubility to wax and units with high solubility to resins exist as blocks; polymers or oligomers in which one of out units with high solubility to wax and units with high solubility to resins is grafted onto the other; unsaturated hydrocarbons such as ethylene, propylene, butene, styrene and α-styrene; copolymers of α,β-unsaturated carboxylic acids such as acrylic acid, methacrylic acid, maleic acid, maleic acid anhydride, itaconic acid or itaconic acid anhydride, or esters or copolymers with anhydrides of those; or blocks of vinyl resins and polyester or grafts thereof.

As the above-described units with high solubility to wax, examples that can be cited include: long-chain alkyl groups with 12 or more carbons and polyolefin, polypropylene, polybutene, polybutadiene and copolymers thereof. As units with high solubility to resin, polyester and vinyl resins can be cited.

The electric charge control agent will now be described.

As the electric charge control agent, those that are commonly known can be used, and for example these include nigrosin dye, triphenyl methane dye, metal complex dye containing chrome, molybdate chelate pigment, rhodamine dye, alkoxy amines, quaternary ammonium salts (including denatured fluorine quaternary ammonium salts), alkyl amides, phosphorus alone or in compounds, tungsten alone or in compounds, fluorine activators, metal salts of salicylic acid and metal salts of salicylic acid derivatives. Specific examples that can be cited include: the nigrosin dye Bontron 03, the quaternary ammonium salt Bontron P-51, the azo pigment containing metal Bontron S-34, the oxynaphthoeic acid metal complex E-82, the salicylic acid type metal complex E-84, the phenol type condensate E-89 (the above all manufactured by Orient Chemical Industries Ltd., the quaternary ammonium salt molybden complexes TP-302 and TP-415 (the above both manufactured by Hodogaya Chemical Co. Ltd.), the quaternary ammonium salt Copy Charge PSY VP2038, the triphenyl methane derivative Copy Blue PR, the quaternary ammonium salts Copy Charge NEG VP2036 and Copy Charge NX VP434 (the above manufactured by Hoechst), LRA-901 and the boron complex LR-147 (manufactured by Japan Carlit Co. Ltd.), copper phthalocyanine, perylene, quinacridone, azo type pigments and other compounds of polymer types having functional groups such as sulfonate groups, carboxyl groups or quaternary ammonium salts. Of these, materials that control the negative polarity of the toner are preferably used.

The amount of electric charge control agent used is determined by the type of binder resin, the absence or presence of additives used as necessary and the method of manufacturing the toner, including the dispersion method, and while it is not unmistakably restricted, typically the amount used is in the range of 0.1 parts by mass to 10 parts by mass with respect to 100 parts by mass of binder resin. Preferably, the range is 0.2 parts by mass to 5 parts by mass. When 10 parts by mass is exceeded, the electrification of the toner becomes too large, which causes the efficacy of the charge control agent to diminish, the static electric adsorption to the developing roller increases, the fluidity of the developer decreases and a decrease in image brightness occurs.

The colorant will now be described.

As the colorant, the following types of commonly known colorants can be used.

Carbon black, nigrosin pigment, iron black, naphthol yellow S, Hansa yellow (10G, 5G, G), cadmium yellow, yellow iron oxide, yellow ochre, chrome yellow, titanium yellow, polyazo yellow, oil yellow, Hansa yellow (GR, A, R, N, R), pigment yellow L, benzidine yellow (G, GR), permanent yellow 9NCG), vulcan fast yellow (5G, R), tartrazine lake, quinoline yellow lake, antrazan yellow BGL, isoindolinone yellow, red ocher, minimum, vermilion lead, cadmium red, cadmium mercury red, antimony vermilion, permanent red 4R, para red, faise red, p-chloro o-nitroaniline red, lithol fast Scarlet G, brilliant fast scarlet, brilliant carmine BS, permanent red (F2 R and F4 R, FRL, FRLL, F4RH), fast scarlet VD, vulcan fast rubine B, brilliant scarlet G, lithol rubine GX, permanent red F5R, brilliant carmin 6B, pigment scarlet 3B, Bordeaux 5B, toluidine maroon, and permanent Bordeaux F2K, helio Bordeaux BL, Bordeaux 10B, a BON maroon light, a BON maroon medium, eosine lake, rhodamine lake B, rhodamine lake Y, alizarin lake, thioindigo red B, thioindigo maroon, oil red, quinacridone red, pyrazolone red, polyazo red, chromium vermilion, benzidine orange, perynone orange, oil orange, cobalt blue, cerulean blue, alkali blue lake, peacock blue lake, Victoria blue lake, non-metal phthalocyanine blue, phthalocyanine blue, fast sky blue, indanthrene blue (RS, BC), indigo, ultramarine blue, navy blue, anthraquinone blue, fast violet B, methyl violet lake, cobalt violet, manganese violet, dioxane violet, anthraquinone violet, chrome green, zinc green, chrome oxide, viridian, emerald green, pigment green B, naphthol green B, green gold, acid green lake, Malachite green lake, phthalocyanine green, anthraquinone green, titanium oxide, zinc white, lithopone and mixtures thereof can be used.

The amount of colorant used is generally 1%-15% by mass with respect to the toner, and more preferably 3%-10% by mass.

The colorant used in the present invention can also be used as a master batch combined with resin. As the binder resin kneaded with the master batch or manufacturing of the master batch, in addition to the previously listed polyester and vinyl resins, rosin, denatured rosin, terpene resin, aliphatic or alicyclic hydrocarbon resin, aromatic petroleum resin, paraffin chloride and paraffin wax can be cited, and these may be used either alone or in mixtures.

The external additive will now be described.

In the present invention, one or more types of inorganic fine particles can be preferably used as the external additive which supports the fluidity, electrostatic property, developing property and transfer property of the toner particles.

The relative surface measured by the BET method for inorganic fine particles is preferably 30 m²/g to 300 m²/g, and the primary particle diameter is preferably 10 nm to 50 nm.

As concrete examples of the inorganic fine particles, silicon oxide, zinc oxide, tin oxide, silica sand, titanium oxide, clay, mica, Wollastonite, diatom earth, chrome oxide, cerium oxide, iron red, antimony trioxide, magnesium oxide, aluminum oxide, zirconium oxide, barium sulfate, barium carbonate, calcium carbonate, silicon carbide, silicon nitride and the like can be cited.

When the primary particle diameter of the external additive is 10 nm or less, the external agent integration into the toner worsens, fluctuations in image deterioration become large and worsen through durability. When the primary particle diameter of the external additive is 50 nm or greater, separation of the external additive from the toner becomes more abundant and filming occurs on the photoconductor body. It is more preferable for the diameter to be 10 nm to 30 nm.

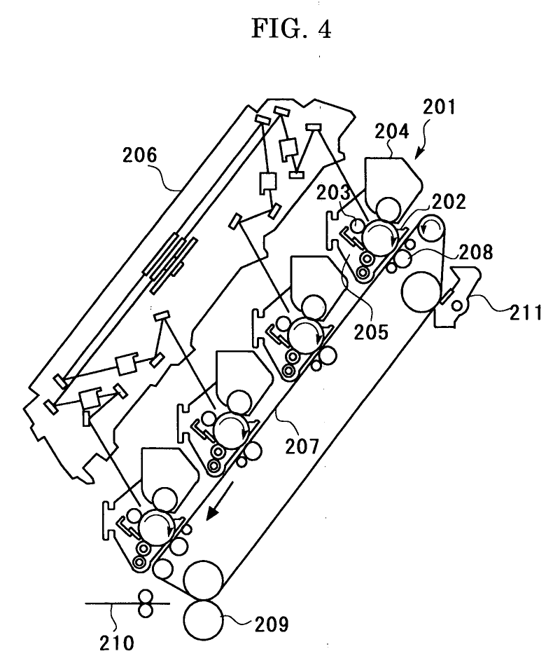

FIG. 4 shows a cross-sectional view of an apparatus for forming an image, equipped with the developing apparatus and process cartridge of an embodiment of the present invention.

Each process cartridge unit 201 is made up of a photoconductor drum 202, a charged roller 203, a developing apparatus 204, and a cleaning unit 205 combined into a single unit. Each process cartridge unit 201 is composed so as to be exchangeable by removing the stopper of each.

The photoconductor drum 202 rotates at a circumferential speed of 150 mm/sec in the direction indicated by the arrow.

The charged roller 203 presses against the surface of the photoconductor drum 202, and rotates through the rotation of the photoconductor drum 202. A predetermined bias is applied to the charged roller 203 by an unrepresented high-voltage power supply so that the surface of the photoconductor drum 202 is charged to −500V.

An exposure unit 206 forms an electrostatic image by exposing image information on the photoconductor drum 202. An LED and a laser beam scanner that uses a laser diode are used in this exposure unit 206.

The developing apparatus 204 uses one component contact developing and makes the electrostatic image on the photoconductor drum 202 appear as a toner image. A predetermined developing bias is supplied from an unrepresented high voltage power supply to the developing apparatus 204.

The photoconductor cleaning unit 205 accomplishes cleaning of residual toner from the surface of the photoconductor drum 202.

Four of the process cartridge units 201 are lined up in the direction of movement of the intermediate transfer belt 207 and form visible images in the following order: yellow, cyan, magenta and black. A primary transfer bias is applied to the primary transfer roller 208 and the toner image on the surface of the photoconductor drum 202 is transferred to the surface of the intermediate transfer belt 207. The intermediate transfer belt 207 is driven in the direction indicated by the arrow in the drawing by an unrepresented drive motor, and a full-color image is formed by visible images in each color being transferred in succession to its surface.

The full color image that is formed is transferred to the paper 210, which is the transfer material, by a predetermined voltage being applied to the secondary transfer roller 209, and is fixed and output by an unrepresented fixing apparatus. Toner particles that failed to be transferred to the secondary transfer roller 209 and left on the intermediate transfer belt 207 are recovered by a transfer belt cleaning unit 211.

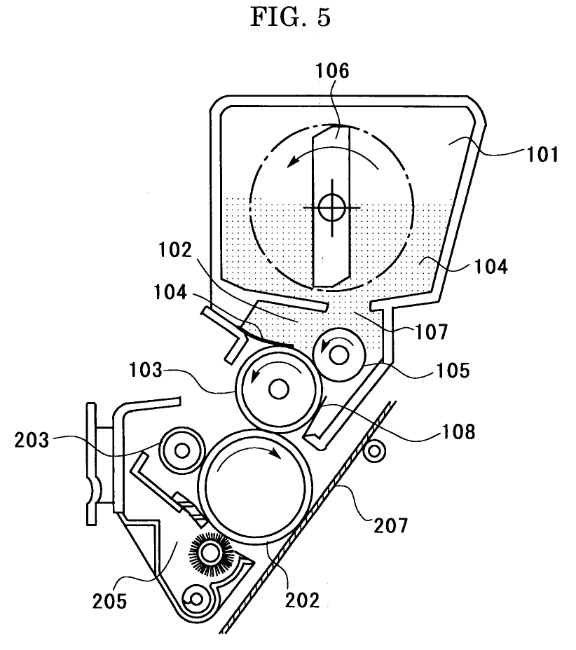

FIG. 5 shows a cross-sectional view of the developing apparatus and process cartridge according to an embodiment of the present invention.

The developing apparatus 204 is made up of a toner storage chamber 101 for storing toner and a toner supply chamber 102 provided below the toner storage chamber 101. Below the storage supply chamber 102, a developing roller 103, a layer regulating member 104 that makes contact with the developing roller 103, and a supply roller 105 are provided. The developing roller 103 is positioned in contact with the photoconductor drum 2 and a predetermined developing bias is applied from an unrepresented high-voltage power supply.

A toner stirring member 106 is provided inside the toner storage chamber 101 and rotating it in a counterclockwise direction provides the stored toner with fluidity and promotes downward movement toward the toner supply chamber 102 via an opening 107. The opening 107 is provided directly above the supply roller, and the only thing directly above the layer regulating member 104 is a wall that divides the toner storage chamber 101 and the toner supply chamber 102. The surface of the supply roller 105 is covered with a foam material having a structure containing cells, and in addition to toner that has been carried to the toner supply chamber 102 efficiently adhering thereto, toner deterioration is prevented by concentration of pressure at the area of contact with the developing roller 103. In addition, an electrically conductive material containing carbon fine particles is used for the foam material, and the electrical resistance is set to 10³ to 10¹³Ω. A supply bias offset in the same direction as the electrification polarity of the toner with respect to the developing bias is applied to the supply roller 105. This supply bias acts in the direction in which the preliminarily charged toner is pressed to the developing roller 103 at the area of contact with the developing roller 103. The supply roller 105 rotates in a counterclockwise direction and coats the surface of the developing roller 103 with the toner that has adhered to its surface.

A roller covered with an elastic rubber layer is used in the developing roller 103, and furthermore a surface coating layer made of a readily chargeable material having the opposite polarity as the toner is provided on the surface thereof. The elastic rubber layer is set to a hardness of 60 degrees or less under JIS-A in order to maintain a uniform contact state with the photoconductor drum 202, and the electrical resistance is set to 10³ to 10¹⁰Ω in order to operate the developing bias function. The surface coarseness is set to 0.3 μm to 2.0 μm under Ra so that the necessary quantity of toner is retained on the surface. The developing roller 103 rotates in a counterclockwise direction and conveys the toner retained on the surface thereof to the facing position on the layer regulating member 104 and the photoconductor drum 202.

The layer regulating member is provided in a position lower than the position of contact between the supply roller and the developing roller 103. The layer regulating member uses a metal plate spring material such as SUS or phosphor bronze, and because its free edge side contacts the surface of the developing roller 103 with a pressing force of 10N/m to 40 N/m, the toner that has passed under this pressure forms a thin layer and is endowed with electrical charge through friction electrification. Furthermore, in order to supplement friction electrification, a control bias is applied to the layer regulating member with a value offset in the same direction as the charge polarity of the toner with respect to the developing bias.

As the rubber elastic material that makes up the surface of the developing roller, there are no particular restrictions but, for example, styrene-butadiene copolymer rubber, acrylonitrile-butadien copolymer rubber, acrylic rubber, epichlorohydrin rubber, urethane rubber, silicone rubber or a blend of two or more of these can be cited. Among these, a blended rubber of epichlorohydrin rubber and an acrylonitrile-butadiene copolymer rubber are preferably used.

The developing roller used in the present invention is, for example, manufactured by covering the outer circumference of an electrically conductive shaft with a rubber elastic material. The electrically conductive shaft is, for example, made of a metal such as stainless steel.

The photoconductor drum 2 rotates in a clockwise direction and accordingly the surface of the developing roller 103 moves in the same direction as the direction of progress of the photoconductor drum 202 in a position facing the photoconductor drum 202.

The toner that has been made into a thin layer is conveyed to the facing position of the photoconductor drum 202 through the rotation of the developing roller 103 and moves to and is developed on the surface of the photoconductor drum 202 in accordance with the latent image electric field formed by the electrostatic image on the photoconductor drum and the developing bias applied to the developing roller 103.

A seal 108 is provided in contact with the developing roller 103 at the place where the toner remaining on the developing roller 103 without being developed on the photoconductor drum 202 returns to the toner supply chamber 102, and the toner is sealed so as to not leak outside the developing apparatus.

The configuration of a charging member for a latent electrostatic image bearing member (photoconductor) will now be explained.

The charging member used in the present invention is provided with a core, a conductive layer on this core and a surface layer that covers this conductive layer, and the whole is formed into a cylindrical shape. Electric potentials applied to the core by a power supply are applied to the photoconductor drum 202 via the conductive layer and surface layer, so that the surface of the photoconductor drum 202 becomes electrified.

The core of the charging member is positioned along the length of the photoconductor drum 202 (parallel with the axis of the photoconductor drum 202), and the charging member as a whole is pressed against the photoconductor drum 202 with a predetermined pressing force. Through this, a portion of the surface of the photoconductor drum 202 and a portion of the surface of the charging member are in contact with each other along the lengthwise direction of each, so that a contact nip of predetermined width is formed. The photoconductor drum 202 is rotationally driven by an unrepresented driving means, and accompanying this, the charging member interlockingly rotates.

The electrification of the photoconductor drum 202 by a power supply is accomplished via the neighborhood of the above-described contact nip. Via the contact nip, the surface of the charging member and the region being electrified on the surface of the photoconductor drum 202 (corresponding to the length of the charging member) are uniformly in contact, and through this the region being electrified on the surface of the photoconductor drum 202 becomes uniform.

The electrically conductive layer of the charging member is non-metallic, and in order to ensure a stable contact status with the photoconductor drum 202, a material of low hardness can be preferably used. For example, resins such as polyurethane, polyether, polyvinyl alcohol or the like, or rubber such as a hydrin type, EPDM, NBR or the like can be used. As the electrically conductive material, carbon black, graphite, titanium oxide, zinc oxide and the like can be cited. In addition, for the surface layer a material having a resistance value of medium resistance (10² to 10¹⁰Ω) is used. For example, as the resin, nylon, polyamide, polyimide, polyurethane, polyester, silicon, Teflon, polyacetylene, polypyrol, polythiophen, polycarbonate, polyvinyl and the like can be used, but in order to increase the contact angle with water, a fluorine resin is preferably used. As examples of fluorine resins, polyvinylidene fluoride, polyethylene fluoride, vinylidene fluoride-ethylene tetrafluoride copolymer, vinylidene fluoride-ethylene tetra fluoride-propylene hexafluoride copolymer or the like can be cited.

Furthermore, electrically conductive materials such as carbon black, graphite, titanium oxide, zinc oxide, tin oxide, iron oxide or the like may be suitably added for the purpose of adjusting the material's resistance to a medium level.

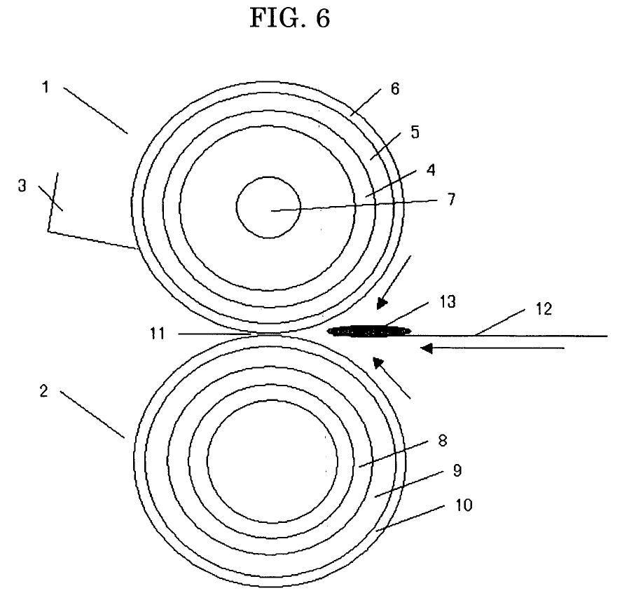

As the oilless fixing apparatus, the fixing apparatus whose overview is shown in FIG. 6 can be preferably used. The fixing apparatus in FIG. 6 uses a heating roller 1 as a heating member and a pressure roller 2 as a pressure member. More precisely, the apparatus is equipped with a heating roller 1, a pressure roller 2 that presses against the heating roller 1, and a separation plate 3 for separating the post-fixing sheet from the heating roller 1. The heating roller 1 generally has an electric layer 5 and a surface layer 6 on an aluminum core 4, and a heater 7 is provided inside the aluminum core 4. The pressure roller generally has an elastic layer 9 and a surface layer 10 on an aluminum core 8. The material of the elastic layer 5 and the elastic layer 9 is not particularly limited, but silicone rubber is preferable. The material of the surface layer 6 and the surface layer 10 is not particularly limited, but a fluorine resin is preferable, and PFA is particularly preferable.

In FIG. 6, a nip 11 is formed at the pressure contact location between the heating roller 1 and the pressure roller 2, and the nip composition of the pressure contact location is preferably an indentation toward the top in the drawing from the perspective of making the fixing separation property advantageous. Through this, when a full-color image is fixed, the phenomenon of the recording sheet 12 wrapping toward the heating roller 1 can be curtailed. Fixing is accomplished by passing the recording sheet 12 bearing the toner image 13 from right to left in the drawing at the pressure contact location.

Waterbased particle (polymer) toners can achieve the numerical range of the parameter for “torque” of the present invention, but pulverized toners have difficulty in achieving this unless the following factors are balanced. The irregularity (circularity) of the pulverized toner, the exposure amount of the surface wax, the adhesion state of external additives such as silica, the easy occurrence of spacer effects and the like are the primary factors influencing this parameter, and it is necessary to achieve this by finding a balance. If atypical shaping progresses, the torque tends to increase, and if the surface wax exposure amount increases, the torque tends to increase. When the adhesion state of the external additives becomes too strong, the torque increases through embedding with the passage of time. When an external additive having a large particle diameter, for example large-grain silica having 70 nm to 500 nm particle diameter, is added, a spacer effect occurs readily among toner particles, it often suppresses torque.

### EXAMPLES

Examples will be described below.

First, the method of manufacturing toners for Examples 1 to 11 and Comparative Examples 1 to 6 and 9 to 10 will be explained.

### (Preparation of First Binder Resin)

As vinyl monomers, 600 g of styrene, 100 g of butyl acrylate and 30 g of acrylic acid were poured into drip funnel along with 30 g of dicumyl peroxide as a polymerization initiator. Out of the polyester monomers, as polyols 1230 g of polyoxy propylene (2,2)-2,2-bis(4-hydroxy phenyl)propane, 290 g of polyoxy ethylene (2,2)-2,2-bis(4-hydroxy phenyl)propane, 250 g of isododecenyl succinic acid anhydride, 310 g of terephthalic acid, 180 g of 1,2,4-benzene tricarboxylic acid anhydride; as an esterization catalyst, 7 g of dibutyl tin oxide; as a wax, 4 parts by mass of paraffin wax (melting point 73.3° C., with 4° C. as the halfvalue magnitude of heat-absorption peak when the temperature is rising, as measured by a differential scanning calorimeter) with respect to 100 parts by mass of the prepared monomer were placed in a five-liter, four-opening flask equipped with a thermometer, stainless steel agitator, pouring-type condenser and nitrogen introduction tube. The result was stirred at a temperature of 160° C. in a nitrogen atmosphere in a mantle heater and the mixture of the vinyl monomer resins and polymerization initiators was dripped from the drip funnel for one hour. After the polymerization reaction was allowed to mature for two hours with the temperature maintained at 160° C., the temperature was increased to 230° C. and a polycondensation reaction was accomplished. The degree of polymerization was traced through the softening point measured using a fixed load extrusion fine tube rheometer, and the reaction was concluded when the desired softening point was achieved, and thereby Resin H1 was obtained. The resin's softening point was 130° C.

### (Preparation of Second Binder Resin)

As polyols, 2210 g of polyoxy propylene (2,2)-2,2-bis(4-hydroxy phenyl)propane, 850 g of terephthalic acid, 120 g of 1,2,4-benzene tricarboxylic acid anhydride and, as an esterization catalyst, 0.5 g of dibutyl tin oxide were poured into a five-liter, four-opening flask equipped with a thermometer, stainless steel agitator, pouring-type condenser and nitrogen introduction tube, and a polycondensation reaction was accomplished by raising the temperature to 230° C. in a nitrogen atmosphere in a mantle heater. The degree of polymerization was traced through the softening point measured using a fixed load extrusion fine tube rheometer, and the reaction was concluded when the desired softening point was achieved, and thereby Resin L1 was obtained. The resin's softening point was 115° C.

### (Preparation of Toner Particles)

After a master batch equivalent to containing 4 parts by mass of C.I. Pigment Red 57-1 with respect to 100 parts by mass of a binder resin composed of the first and second binder resins (including the weight of the added wax) was sufficiently mixed using a Henschel mixer, it was melted and kneaded using a twin-screw kneader/extruder (PCM-30, made by Ikegai Tekko Co. Ltd.) and the resulting kneaded product was rolled to a thickness of 2 mm by a cold press roller and cooled into a cold pellet, followed by crude pulverization using a phaser mill. Following this, fine pulverization to an average particle diameter of 10 μm to 12 μm was accomplished using a mechanical pulverizer (KTM, made by Kawasaki Heavy Industries Ltd.), and furthermore after being pulverized while being rough sorted by a jet pulverizer, fine powder sorting was accomplished using a rotor sorter (100ATP Teeplex sorter, made by Hosokawa Micron Ltd.), and colored resin particles 1 of the desired diameter and circularity were obtained. To 100 parts by mass of these colored resin particles 1, the desired amount (parts by mass) of TS530, an inorganic fine particle made by Cab-o-Sil, was added, the result was mixed with a Henschel mixer and magenta toner particles were obtained.

The method of producing the toner of Comparative Example 7 will now be explained.

### (Example of Production of Polarized Polymer)

In a reaction vessel capable of applying pressure and equipped with a convection tube, an agitator, a thermometer, a nitrogen introduction tube, a drip apparatus and a depressurization apparatus, 150 parts by mass of methanol, 250 parts by mass of 2-butanone and 100 parts by mass of 2-propanol were added as solvents, along with 84 parts by mass of styrene, 13 parts by mass of acrylate 2-ethyl hexyl and 3 parts by mass 2-acrylamide-2-methylpropane sulfonate (AMPS) as monomers, and these were heated to the convection tube while being stirred. A solution made of 2 parts by mass of t-butyl peroxy-isobutyrate as a polymerization initiator diluted by 20 parts by mass of 2-butanon was added dropwise over 30 minutes, then the result was stirred continuously for five hours, following which a solution made of 1 part by mass of t-butyl peroxy-isobutyrate diluted by 20 parts by mass 2-butanon was added dropwise over 30 minutes and the result was again stirred for five hours to complete polymerization.

The polymer obtained after depressurizing removal of the polymer solvent was crude pulverized to 100 μm or less using a cutter mill on which a screen with 100 μm openings was mounted.

### (Example of Toner Production)

In a two-liter four-opening flask equipped with a TK Homo Mixer high-speed agitator, 910 parts by mass of ion exchange water and 1 part by mass of polyvinyl alcohol were added and made into a dispersion agent type by adjusting the number of rotations to 12,000 rotations and heating to 60° C.

On the other hand, the dispersion material was:

| | |
|---|---|
| Styrene monomer | 165 parts by mass |
| n-butyl acrylate monomer | 35 parts by mass |
| phthalocyanine | 10 parts by mass |
| (C.I. Pigment Blue 15:3) | |
| polyester resin | 30 parts by mass |
| (a polycondensate of isophthalic acid and propylene | |
| oxide denatured bisphenol A, | |
| with Tg = 70° C., Mw = 10000 and Mn = 6000) | |
| Polarized polymer (1) | 2 parts by mass |
| Aluminum salicylic acid compound | 4 parts by mass |
| (Bontron E-88, made by Orient Chemical Industries | |
| Ltd.) | |
| divinyl benzene | 0.2 parts by mass |
| stearyl stearate wax (DSC main peak 60° C.) | 30 parts by mass |

The above mixture was dispersed for three hours using an Attritor, and then the dispersed product to which 5 parts by mass of the polymerization initiation agent 2,2′-azobis(2,4-dimethyl valeronitrile) had been added was introduced to the above-described dispersion catalyst and granules were formed for 12 minutes while maintaining the number of rotations. Following this, the agitator was switched from the high-speed agitator to a propeller agitator blade, the internal temperature was raised to 65° C. and polymeization was continued for 10 hours at 50 rotations.

After the completion of polymerization, the slurry was cooled, rinsed and dried, a sorting treatment using the Coanda effect was accomplished, granulation adjustment was accomplished and the cyan toner of Comparative Example 7 was obtained.

The method of producing the toner of Comparative Example 8 will now be explained.

The toner of Comparative Example 8 was prepared in a similar manner except that no wax was added during the creation of the first binder resin and that 4 parts by mass of paraffin wax was added during creation of toner particles.

Evaluations conducted using a actual machine will now be explained.

Image evaluations were conducted for different toners using an Ipsio CX3000 color laser printer made by Ricoh Company.

### (Torque Evaluation)

The torque increase amount at the time when the linear speed was reduced by half was measured.

Experiments that showed clogging due to increased torque are evaluated as “B,” while those that showed no clogging are evaluated as “A.”

### (Image Density Unevenness)

Image density unevenness was evaluated in terms of the amount of toner particles attached to the photoconductor upon development of a black solid fill.

Experiments that showed image unevenness due to excess toner conveyance occurred are evaluated as “B.” while those that showed no image unevenness are evaluated as “A.”

### (Fixed Streaks)

Experiments that showed white streaks due to regulated BL fixing upon development of a black solid fill are evaluated as “B, while those that showed no fixed streaks are evaluated as “A.”

### (Poor cleaning (CL))

A method was used in which toner smears were collected by means of tape peeling from the charging roller surface every after printing of a given number of sheets (100 sheets of 5% coverage chart), and the degree of smear was determined by visual inspection or by measurement of smear density. Experiments that are free of toner smearing on printed images are evaluated as “A,” while those that offered toner smearing and caused toner streaks on images are evaluated as “B.”

### (Paper Sheet Winding During Fixation)

A two-component developer created by mixing and stirring 5 parts toner and 95 parts silicone resin coat carrier was poured into a modified device made by removing the fixing device from a Ricoh Ipsio CX7500, adjustments were made so that 1.1±0.1 mg/cm² of toner was developed in a solid image having a 3 mm top margin in the vertical direction on transfer paper (made by Ricoh, type 6200Y graph paper), and six sheets of transfer paper in an unfixed state were output.

Using a fixing test apparatus made by modifying a Ricoh Ipsio CX2500 by removing just the fixing part and changing the fixing belt temperature and belt linear speed to the desired values, fixing on transfer paper was accomplished from the 3 mm of top margin with the belt linear speed set to 125 mm/sec and the fixing belt temperature at 10° C. increments in the range of 140° C. to 190° C. Based on the number of sheets that were successfully fixed without any problems, i.e., without transfer paper being wound around the fixing belt or crumpling and piling up at the exit of the fixing apparatus, evaluations were made on the basis of the following criteria.

### A: The number of sheets that were successfully fixed was 5 or higher.

### B: The number of sheets that were successfully fixed was 4 or less

The evaluation results in Examples and Comparative Examples are shown in Table 1.

In Comparative Example 1, the toner particle diameter is large, granularity deteriorates and image unevenness occurs.

In Comparative Example 2, the toner particle diameter is small, and thus the toner packs and torque increases.

In Comparative Example 3, the average circularity is large, so the torque becomes too low, toner scattering on the image is generated and unevenness occurs.

In addition, poor cleaning occurs.

In Comparative Example 4, the average circularity is small, so the toner packs and the torque increases.

In Comparative Example 5, the wax content is small, so paper wraps around the roller during fixing. In addition, image unevenness is caused by poor luster.

In Comparative Example 6, the wax content is large, so there is a great deal of free wax, this adheres to the regulation blade in the developer and streaking occurs in the image. In addition, adhesion is strong and torque also increases.

In Comparative Example 7, no wax-containing resin was used, as separate resin and wax were used, so there is a large amount of free wax and the torque increases. In addition, this adheres to the regulation blade and streaking occurs in the image.

In Comparative Example 8, a polymer toner is used so the circularity is high, the torque becomes too low, scattering of the toner on the image occurs and unevenness results. In addition, poor cleaning also occurs.

In Comparative Example 9, the external additive amount is large, so torque becomes small, CL blade friction becomes large and poor cleaning occurs.

In Comparative Example 10, the external additive amount is small, the toner core is exposed, the adhesion amount is high and the torque becomes large. In addition, wax adheres readily to the regulation blade, and adhesion streaks occur.

TABLE 1

| | Toner | | | External | Conical rotor | | Actual equipment evaluation | | | | |
|---|---|---|---|---|---|---|---|---|---|---|---|
| | particle | Average | Wax | additive | Vacancy | | | Image | Fixing | Poor | |
| | diameter | circularity | content | amount | ratio | Torque | Torque | unevenness | streaks | CL | Winding |
| Ex. 1 | 10 | 0.930 | 3 | 4 | 58 | 1.0 | A | A | A | A | A |
| Ex. 2 | 6 | 0.890 | 10 | 2.5 | 58 | 2.5 | A | A | A | A | A |
| Ex. 3 | 8.1 | 0.915 | 5 | 3.2 | 58 | 1.6 | A | A | A | A | A |
| Ex. 4 | 10 | 0.915 | 5 | 3.2 | 58 | 1.2 | A | A | A | A | A |
| Ex. 5 | 6 | 0.915 | 5 | 3.2 | 58 | 2.4 | A | A | A | A | A |
| Ex. 6 | 8.1 | 0.930 | 5 | 3.2 | 58 | 1.1 | A | A | A | A | A |
| Ex. 7 | 8.1 | 0.890 | 5 | 3.2 | 58 | 2.3 | A | A | A | A | A |
| Ex. 8 | 8.1 | 0.915 | 3 | 3.2 | 58 | 1.1 | A | A | A | A | A |
| Ex. 9 | 8.1 | 0.915 | 10 | 3.2 | 58 | 2.4 | A | A | A | A | A |
| Ex. 10 | 8.1 | 0.915 | 5 | 4 | 58 | 1.8 | A | A | A | A | A |
| Ex. 11 | 8.1 | 0.915 | 5 | 2.5 | 58 | 2.2 | A | A | A | A | A |
| Comp. Ex. 1 | 10.5 | 0.895 | 4.5 | 3.2 | 58 | 0.9 | A | B | A | A | A |
| Comp. Ex. 2 | 5.5 | 0.915 | 4.4 | 3.2 | 58 | 2.7 | B | A | A | A | A |
| Comp. Ex. 3 | 8.1 | 0.935 | 5.2 | 3.2 | 58 | 0.8 | A | B | A | B | A |
| Comp. Ex. 4 | 8.3 | 0.880 | 4.8 | 3.2 | 58 | 2.9 | B | A | A | A | A |
| Comp. Ex. 5 | 7.8 | 0.901 | 2.5 | 3.2 | 58 | 0.6 | A | B | A | A | B |
| Comp. Ex. 6 | 8.4 | 0.914 | 11 | 3.2 | 58 | 3.2 | B | A | B | A | A |
| Comp. Ex. 7 | 8.0 | 0.915 | 6 | 3.2 | 58 | 2.8 | B | A | B | A | A |
| Comp. Ex. 8 | 7.6 | 0.98 | 6 | 3.2 | 58 | 0.1 | A | B | A | B | A |
| Comp. Ex. 9 | 10 | 0.930 | 3 | 4.5 | 58 | 0.8 | A | A | A | B | A |
| Comp. Ex. 10 | 6 | 0.890 | 10 | 2 | 58 | 2.8 | B | A | B | A | A |

What is claimed is:

1. A pulverized toner for use in a upright developing device, comprising:
a wax-containing resin;
a coloring material; and
an external additive,
wherein the pulverized toner has an average circularity of 0.890 to 0.930, a particle diameter of 6 μm to 10 μm, and a torque of 1.0 mNm to 2.5 mNm at a vacancy ratio of 58% in the pulverized toner as measured by a torque measuring method using a conical rotor, and
wherein the pulverized toner is a wax-containing pulverized toner for non-magnetic one component development.

2. The pulverized toner according to claim 1, wherein the external additive is a flow enhancer and is contained in an amount of 2.5 parts by mass to 4.0 parts by mass per 100 parts by mass of the toner.

3. The pulverized toner according to claim 1, wherein the external additive has a primary particle diameter of 10 nm to 50 nm.

4. The pulverized toner according to claim 1, wherein the external additive is silica and the adhesive strength of the external additive with respect to the pulverized toner is 30% to 80%.

5. The pulverized toner according to claim 1, wherein the wax content of the pulverized toner is 3 parts by mass to 10 parts by mass per 100 parts by mass of the pulverized toner.

6. A upright developing apparatus in which a pulverized toner is used, comprising:
a pulverized toner supply part; and
a developing roller arranged vertically below the pulverized toner supply part,
wherein the pulverized toner is supplied vertically downward, and
wherein the pulverized comprises a wax-containing resin; a coloring material; and an external additive, wherein the pulverized toner has an average circularity of 0.890 to 0.930, a particle diameter of 6 μm to 10 μm, and a torque of 1.0 mNm to 2.5 mNm at a vacancy ratio of 58% in the pulverized toner as measured by a torque measuring method using a conical rotor, and wherein the pulverized toner is a wax-containing pulverized toner for non-magnetic one component development.

7. The upright developing apparatus according to claim 6, further comprising a pulverized toner supply roller that contacts and faces the developing roller.

8. The upright developing apparatus according to claim 6, wherein the supply of the pulverized toner to the developing roller is at least accomplished by gravity.

9. A process cartridge comprising:
a upright developing apparatus in which a pulverized toner is used, the apparatus including:
a pulverized toner supply part; and
a developing roller arranged vertically below the pulverized toner supply part,
wherein the pulverized toner is supplied vertically downward, and
wherein the pulverized comprises a wax-containing resin; a coloring material; and an external additive, wherein the pulverized toner has an average circularity of 0.890 to 0.930, a particle diameter of 6 μm to 10 μm, and a torque of 1.0 mNm to 2.5 mNm at a vacancy ratio of 58% in the pulverized toner as measured by a torque measuring method using a conical rotor, and wherein the pulverized toner is a wax-containing pulverized toner for non-magnetic one component development.

10. An image forming apparatus comprising:
a fixing apparatus; and
a upright developing apparatus in which a pulverized toner is used, the upright developing apparatus including:
a pulverized toner supply part; and
a developing roller arranged vertically below the pulverized toner supply part,
wherein the pulverized toner is supplied vertically downward,
wherein the pulverized comprises a wax-containing resin; a coloring material; and an external additive, wherein the pulverized toner has an average circularity of 0.890 to 0.930, a particle diameter of 6 μm to 10 μm, and a torque of 1.0 mNm to 2.5 mNm at a vacancy ratio of 58% in the pulverized toner as measured by a torque measuring method using a conical rotor, and wherein the pulverized toner is a wax-containing pulverized toner for non-magnetic one component development, and
wherein the fixing apparatus employs two-roll fixing system composed of a heating roller and a pressure roller.

11. An image forming apparatus comprising:
a fixing apparatus; and
a upright developing apparatus in which a pulverized toner is used, the upright developing apparatus including:
a pulverized toner supply part; and
a developing roller arranged vertically below the pulverized toner supply part,
wherein the pulverized toner is supplied vertically downward,
wherein the pulverized comprises a wax-containing resin; a coloring material; and an external additive, wherein the pulverized toner has an average circularity of 0.890 to 0.930, a particle diameter of 6 μm to 10 μm, and a torque of 1.0 mNm to 2.5 mNm at a vacancy ratio of 58% in the pulverized toner as measured by a torque measuring method using a conical rotor, and wherein the pulverized toner is a wax-containing pulverized toner for non-magnetic one component development, and
wherein the fixing apparatus employs oilless fixing that requires no oil coating on a fixing member.

12. An image forming method comprising:
using a pulverized toner which comprises:
a wax-containing resin;
a coloring material; and
an external additive,
wherein the pulverized toner has an average circularity of 0.890 to 0.930, a particle diameter of 6 μm to 10 μm, and a torque of 1.0 mNm to 2.5 mNm at a vacancy ratio 58% in the pulverized toner as measured by a torque measuring method using a conical rotor, and
wherein the pulverized toner is a wax-containing pulverized toner for non-magnetic one component development.
